(19) United States
(12) Patent Application Publication
(10) Pub. No.: US 2016/0036081 A1
(43) Pub. Date: Feb. 4, 2016

(54) Graphene-Based Proton Exchange Membrane for Direct Methanol Fuel Cells

(71) Applicant: UNIVERSITY OF FLORIDA RESEARCH FOUNDATION, INC., Gainesville, FL (US)

(72) Inventors: Saeed Moghaddam, Gainesville, FL (US); Henry Angelo Sodano, Gainesville, FL (US); Abhilash Paneri, Gainesville, FL (US); Yunseon Heo, Gainesville, FL (US); Gregory John Ehlert, Miamisburg, OH (US)

(21) Appl. No.: 14/766,935

(22) PCT Filed: Feb. 12, 2014
(86) PCT No.: PCT/US2014/016019

§ 371 Date: Aug. 10, 2015

Related U.S. Application Data
(60) Provisional application No. 61/763,782, filed on Feb. 12, 2013.

(51) Int. Cl. H01M 8/10; H01M 8/06

(52) U.S. Cl. CPC H01M 8/1016; H01M 8/1004; H01M 8/0637; H01M 2300/0071

(57) ABSTRACT

A proton exchange membrane (PEM) for use in a direct methanol fuel cell (DMFC) is a laminate of graphene oxide (GO) or sulfonated graphene oxide (SGO) platelets. The mean size of the platelets is at least 10 μm in diameter and the platelets are combined as a laminate. By use of sufficiently large platelets, the stability of the PEM and the resistance to methanol permeation is improved dramatically with little penalty to the proton conductivity of the GO or SGO PEM. The methanol resistant PEM permits the use of higher methanol concentrations at the anode of a DMFC, for high cell performance.

### CROSS-REFERENCE TO RELATED APPLICATION

The present application claims the benefit of U.S. Provisional Application Ser. No. 61/763,782, filed Feb. 12, 2013, which is hereby incorporated by reference herein in its entirety, including any figures, tables, or drawings.

### BACKGROUND OF INVENTION

Membranes play a crucial role in separation processes in many energy, environmental, and life science applications, such as, water purification, fuel cells, dialysis, and chemical processes. Selectivity and permeability are key characteristics that determine the efficacy of a membrane for almost any application. Direct methanol fuel cells (DMFCs) are the most promising type of portable fuel cell because of the high energy density of methanol, facility of its storage, and its direct oxidation on the anode catalyst. However, the existing DMFC membrane electrode assemblies (MEAs) deliver a low power density, of about an order of magnitude less, than hydrogen fuel cells. At the heart of the problem are deficiencies of the existing MEAs that suffer from; a) slow kinetics of methanol electro-oxidation at the anode, b) limited operating temperature, c) significant methanol permeation through the membrane (i.e., fuel crossover), particularly at high fuel concentrations, and d) high water permeation through the membrane and cathode water congestion.

For DMFCs, an ideal proton exchange membrane (PEM) would selectively transport only protons from the cell's anode to its cathode. The absence of this ideal membrane has resulted in the evolution of complex, bulky, and expensive fuel cells that employ many auxiliaries designed to deal with deficiencies of the existing PEMs. An ideal, or at least significantly improved, PEM has been widely sought and its development is necessary for advancement of DMFC technology. The major deficiencies of current PEMs are fuel crossover and excessive swelling of the polymer electrolyte membranes at high fuel concentrations. Despite many efforts to develop better membranes, challenges remain. Water channels, typically of a few nanometers in diameter, are crucial to proton transport, but readily allow passage of methanol molecules. Reduction in channel size and blocking water pathways often lead to low proton conductivities.

Understanding transport characteristics of new materials should permit development of better PEMs by tailoring the membrane's material properties at a molecular scale. This bottom-up approach builds inherent functionality into a PEM rather than achieving improvements through a supporting system. Graphene appears to be a suitable platform for development of a methanol barrier or stand-alone PEM for DMFCs as graphene has a single atom thickness yet is impermeable to gas molecules as small as Helium, and, therefore, may permit proton transport while being an otherwise impermeable and selective membrane.

Graphene-based PEMs for hydrogen fuel cells have been reported recently: Ravikumar et al., “Freestanding Sulfonated Graphene Oxide Paper: A New Polymer Electrolyte for Polymer Electrolyte Fuel Cells”, Chemical Communications 48, 5584 (2012); Zarrin et al., “Functionalized Graphene Oxide Nanocomposite Membrane for Low Humidity and High Temperature Proton Exchange Membrane Fuel Cells”, The Journal of Physical Chemistry C 115, 20774-20781 (2011), and Xu et al.; and “A Polybenzimidazole/Sulfonated Graphite Oxide Composite Membrane for High Temperature Polymer Electrolyte Membrane Fuel Cells”, J. Mater. Chem., 21, 11359 (2011). Graphene oxide (GO) is a popular precursor for large-scale synthesis of graphene that is electrically nonconductive with the potential for other properties of an ideal PEM, such as high mechanical strength, ionic selectivity, and interfacial compatibility with carbon-based catalyst supports.

Ravikumar et al., discloses that graphene oxide paper has poor mechanical stability with liquid fuels, but that sulfonic acid functionalized graphite oxide paper prepared from the aryl diazonium salt of sulfanilic acid and GO is an electrolyte for low temperatures with low relative humidity (25%) polymer electrolyte membrane fuel cells (PEMFCs). Ravikumar et al. concluded that several limitations have to be overcome before commercial use, including limitations concerning stability, fuel crossover, and lifetime of a membrane electrode assembly (MEA).

Zarrin et al., discloses that a sulfonic acid-containing group functionalization graphene oxide (F-GO), prepared by reaction of GO with 3-mercaptopropyl trimethoxysilane (MPTMS) followed by oxidation with hydrogen peroxide, could be combined at 5 or 10% with Nafion® to prepare a membrane for low humidity and high temperature PEMFC applications. Zarrin et al. concluded that the composite membranes would be useful for high temperature PEMFCs if they could be shown to have sufficient chemical and mechanical stability.

Xu et al. discloses 2 weight % GO and sulfonated GO in poly(2,20-m-(phenylene)-5,50-di-benzimidazole) (PBI) membranes cast from N,N-dimethylacetamide (DMAc), where the sulfonated GO was prepared by the reaction of GO with chlorosulfonic acid. In H₂/O₂ fuel cell tests, GO/PBI and SGO/PBI membranes with phosphoric acid (PA) showed superior performance to PBI/PA membranes with high loadings of PA.

Viable improvements of stable PEMs for DMFCs have not resulted in membranes that resist methanol crossover and water permeation particularly at high methanol concentrations to increase the kinetics at the anode of the DMFC. There remains a need for viable electrolyte membranes for DMFC applications.

### BRIEF SUMMARY

Improved GO and SGO PEMs are presented with PEMs in the form of laminates of GO or SGO platelets with a mean size of approximately 10 μm or more. The use of sufficiently large platelets improves the stability of the PEM for use in a DMFC. The use of larger platelets suppresses methanol crossover with little penalty to the proton conductivity.

### BRIEF DESCRIPTION OF DRAWINGS

FIG. 1 shows a schematic cross-sectional view of a Graphene-Oxide (GO) membrane, according to an embodiment of the invention, indicating a mass-transfer pathway through the laminate where channels between GO platelets are indicated as breaks in the lines and where dotted lines indicate sites within the platelet that permit proton transport through the GO platelets.

FIG. 2 shows plots of the change in proton conductivity and methanol diffusivity for GO membranes, according to an embodiment of the invention, as the mean platelet size increases.

FIG. 3 shows: a) an XPS plot for a GO PEM, according to an embodiment of the invention, as a composite of peaks for individual carbon species absorbing at 288.8 eV for COOH, 287.7 eV for C═O, 286.6 for C—C, and 280 for C—OH and Ph—OH; and b) an FTIR spectroscopy plot for the GO PEM displaying peaks at 1040 cm⁻¹ (C—O—C), 1640 cm⁻¹ (C(═O)OH), 1715 cm⁻¹ (C═O), and 3220 cm⁻¹ (C—OH, COOH, and Ph—OH).

FIG. 4 shows a plot of the GO platelet (flake) size produced by different sonication periods.

FIG. 5 shows a) a scanning electron microscopy (SEM) image of a GO sample used to measure flake sizes of: b) as prepared GO flakes; c) GO flakes after sonication for 10 minutes; and d) GO flakes after sonication for 20 minutes.

FIG. 6 shows a photograph of a freestanding Graphene-Oxide (GO) membrane, according to an embodiment of the invention.

FIG. 7 shows a scanning electron microscopy (SEM) image of the cross-section of freestanding Graphene-Oxide (GO) membrane, according to an embodiment of the invention.

FIG. 8 shows a plot of water uptake (%) vs % RH for a GO membrane, according to embodiments of the invention.

FIG. 9 shows TEM images from a single sheet of GO, center with: a) FFT of the GO flake showing with 6 bright dots indicating a single layer GO; b) a further magnified region where large defects are apparent; c) a further magnified region displaying a very low defect concentration; and d) a further magnified region displaying relatively smaller defects.

FIG. 10 shows a schematic of the electrochemical cell for PEM characterization.

FIG. 11 shows plots of the normalized proton conductivity versus the methanol concentration for no membrane, a Nafion® 117 membrane, and a GO membrane, according to an embodiment of the invention.

FIG. 12 shows schematics for membrane electrode assemblies for a) (4) GO membrane sandwiched between two (2) Nafion 211® half electrodes, according to an embodiment of the invention, and b) (2) Nafion 212®, with (3) catalyst layers and (1) current collectors.

FIG. 13 shows XRD spectra of the GO laminate, according to an embodiment of the invention, and its parent graphite material.

FIG. 14 shows chronopotentiometry plots of: a) a GO membrane, according to an embodiment of the invention, at 10 M methanol concentration over 3 cycles; and b) a Nafion® 117 membrane at 3 M methanol concentration, where the arrow indicates rupturing of the membrane.

FIG. 15 shows plots of a V-I curve and Power density for MEAs with a GO membrane, according to an embodiment of the invention, and a Nafion® membrane using 5 M and 10 M methanol solutions.

### DETAILED DISCLOSURE

Embodiments of the invention are directed to proton exchange membranes (PEMs) that enhance the function of direct methanol fuel cells (DMFCs) and to DMFCs comprising the PEMs. PEMs, according to embodiments of the invention, are prepared by laminating graphene oxide (GO) platelets or sulfonated graphene oxide (SGO) platelets. It was discovered that the problems of stability, fuel crossover, and lifetime of a membrane electrode assembly (MEA) observed for GO membranes by Ravikumar et al. were alleviated with only small decreases in the PEM's conductivity by the use of relatively large GO sheets, for example, platelets with a mean size of 16 μm. For example, GO or SGO platelets can be of a diameter of at least 10 μm, at least 15 μm, or at least 20 μm. The PEMs are laminates of the platelets stacked in an orderly fashion to be readily supported or self-supported in a DMFC. For example, the PEMs can be 15 μm in thickness, 10 μm in thickness, or 5 μm in thickness, as is appropriate for a given mean size of the platelets.

Upon hydration of a GO membrane, a network of nano-capillaries forms between the GO platelets where the nano-capillaries are potential water molecule pathways through the laminated structure, as schematically illustrated in FIG. 1. These capillaries are potential ion conduction pathways, similar to those of traditional polymer electrolytes such as Nafion® with sulfonate surface groups, but with a lower acidity level. In contrast to Nafion® membranes, where the effective length of water channel and the ion path length increases with membrane thickness leads to a linear decrease in ion conductivity with membrane thickness, as suggested by the model shown in FIG. 1, the effective ion path length potentially changes with the mean platelet size. However, as the platelet size increases, the length of the proton transport channels, for the GO PEMs, according to an embodiment of the invention, appears to increase little with the size of the platelets.

In an exemplary embodiment of the invention, 12-micron-thick GO PEMs were prepared from platelets with mean sizes of 15.8 μm, 10.4 μm, and 2 μm. Surprisingly, DMFCs comprising a PEM from the largest platelets displayed 80% of the conductivity of a similarly thick PEM from the smallest platelets, even though the ion path length parallel to the face of the PEM suggested in FIG. 1 would increase nearly 8-fold due to the platelet size difference. This retention of proton conductivity implies the existence of proton selective atomic formations and/or defects within the GO platelets, where those formations are of sufficient size and/or structure to permit proton transfer through the platelet. GO has known inhomogeneity and defects relative to pristine graphene sheets.

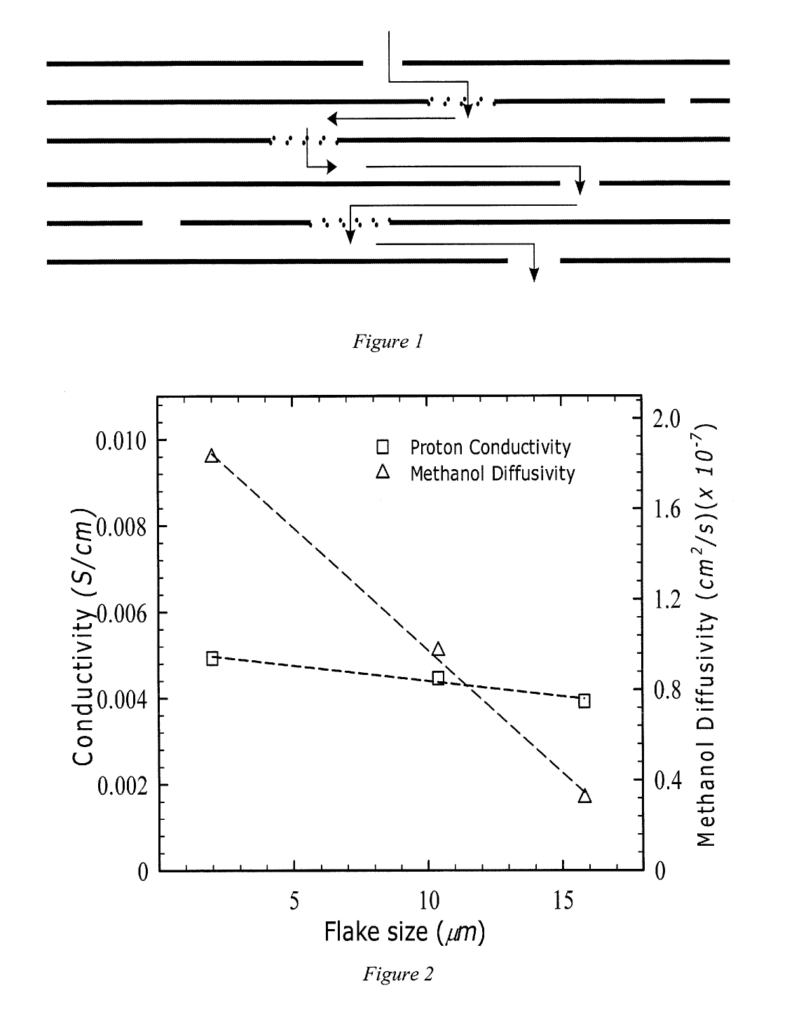

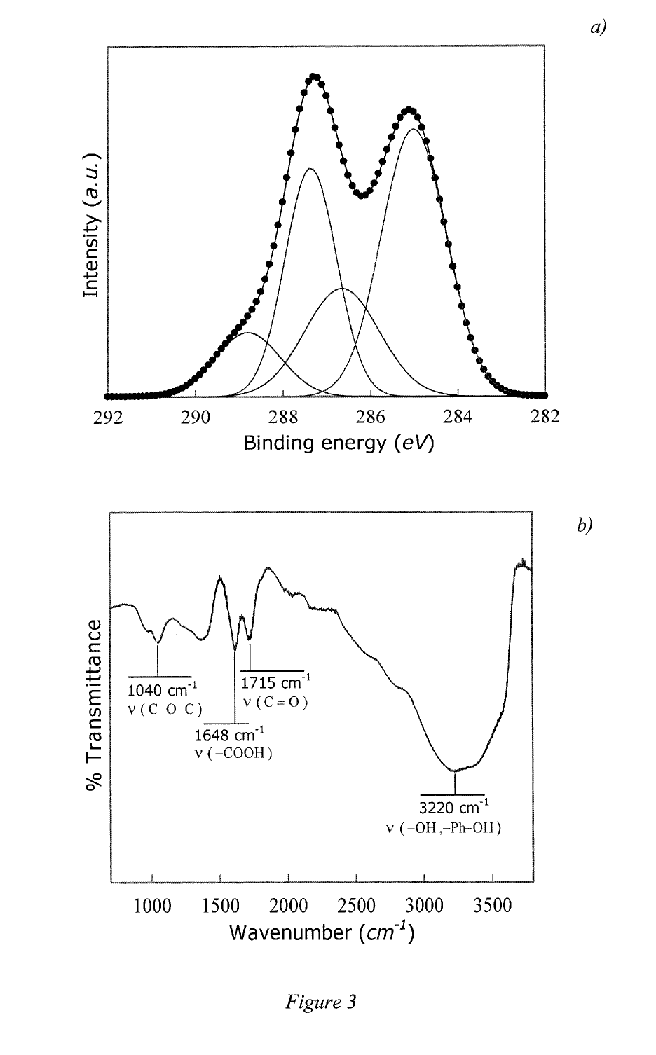

Although PEMs from large GO platelets display little sacrifice of the conductivity relative to those of small platelets, FIG. 2 illustrates that the methanol diffusivity through the PEMs from large platelets is significantly diminished from that of smaller platelets. Measurements of the effects of methanol concentration on proton conductivity showed that the degree of decline in proton conductivity for GO is significantly less than that observed for currently used Nafion® membranes. Furthermore, GO membranes do not swell in highly concentrated methanol solutions, unlike Nafion® membranes that exhibit excessive swelling and disintegration under similar conditions. In view of the general view of the local chemical structures in GO, there are believed to be “islands” of oxidative functionality among graphitic regions. XPS and FTIR spectroscopy, as shown in FIG. 3, performed on the GO PEMs indicate the presence of oxidative functionality.

In another embodiment of the invention, a SGO PEM was prepared and used in DMFCs. The SGO PEM is a SGO laminate. In an exemplary embodiment GO was dispersed in N,N-dimethylacetamide (DMAc), and chlorosulphonic acid was added to the dispersion to form sulfonic acid groups on the graphene platelets. Once the reaction between chlorosulphonic acid and GO appeared to be complete, the suspension was vacuum filtered to obtain a SGO PEM of about 12 μm in thickness. Overall, the proton to methanol selectivity of the graphene based PEM is about two orders of magnitude higher than state of the art Nafion® membranes, which permits operation of a DMFC at a much higher fuel concentration.

### Methods and Materials

GO platelets were synthesized from graphite powder using Hummers' method, as disclosed in Hummers, Jr. et al., J. Am. Chem. Soc., 80 (6), 1339 (1958), which is incorporated herein by reference. A 69 mL portion of concentrated sulfuric acid (H₂SO₄) was added to a mixture of 3.0 g of natural graphite flakes and 1.5 g of sodium nitrate (NaNO₃). The mixture was cooled to 0° C. using an ice bath. A 9.0 g portion of potassium permanganate (KMnO₄) was slowly added to the cold solution at a rate that kept the temperature of the reaction mixture below 20° C. After complete KMnO₄ addition, the mixture was warmed to 35° C. and stirred for 2 hours. Deionized water (138 mL) was slowly added to the mixture and heat was applied to maintain a temperature of 98° C. for 15 minutes. Heating was stopped and the mixture was cooled in a water bath for 10 minutes. An additional 420 mL of water and 3 mL of 30% hydrogen peroxide (H₂O₂) solution were added, the mixture cooled, and solids settled. The acidic supernatant was removed using a centrifuge and the remaining solids were washed with DI water, 30% hydrochloric acid (HCl), and ethanol (CH₃CH₂OH), sequentially. The remaining solids were diluted and exfoliated in an ultrasonic bath.

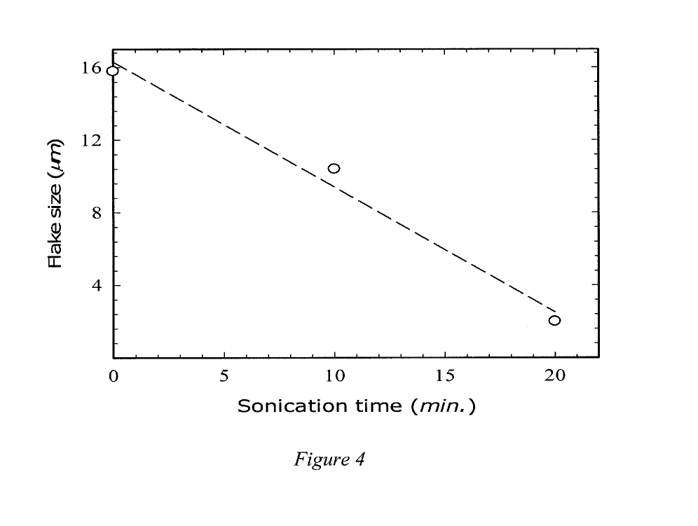

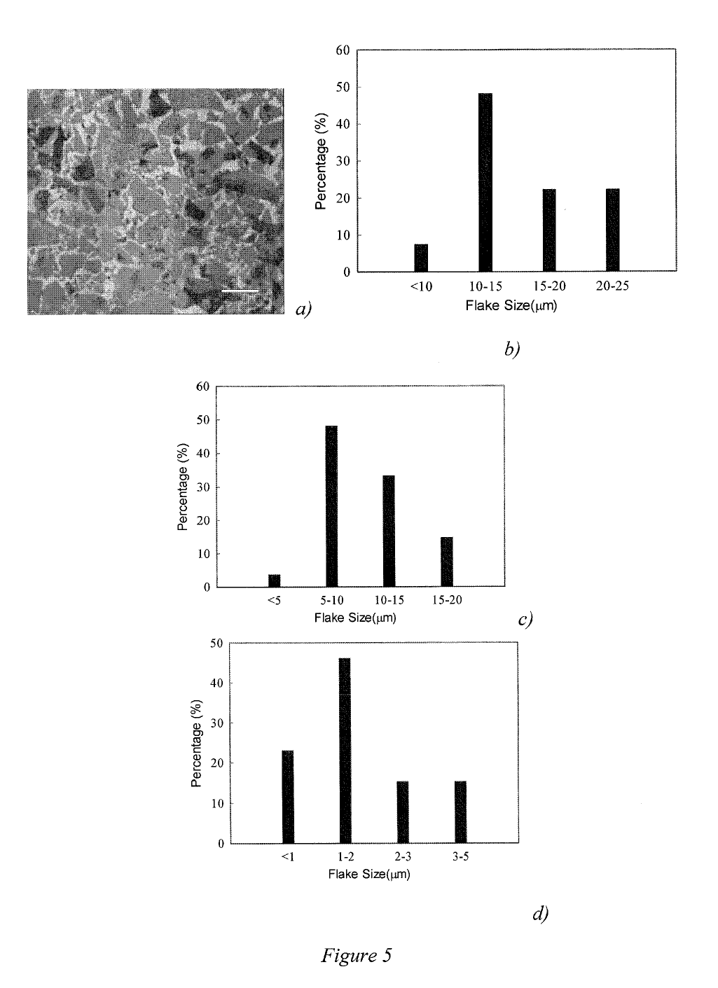

GO platelets with a mean size of 15.8 μm were isolated. GO flakes of 10.4 μm and 2 μm mean sizes were formed by bath sonication for 10 and 20 minutes after exfoliation, respectively. GO flake sizes were measured using Scanning Electron Microscopy (SEM) on sheets isolated on a mica substrate using a Langmuir-Blodgett method. The projected area diameter method was used to calculate the platelet size, as the method is useful for calculating the area of irregular shaped particles. This area was used to characterize the platelet size as the diameter of a perfect circle. ImageJ® software was used to calculate the projected area of each platelet and at least 30 platelets from each sample were selected and averaged. The flake size of graphene oxide decreases as sonication time increases, as shown in FIGS. 4 and 5.

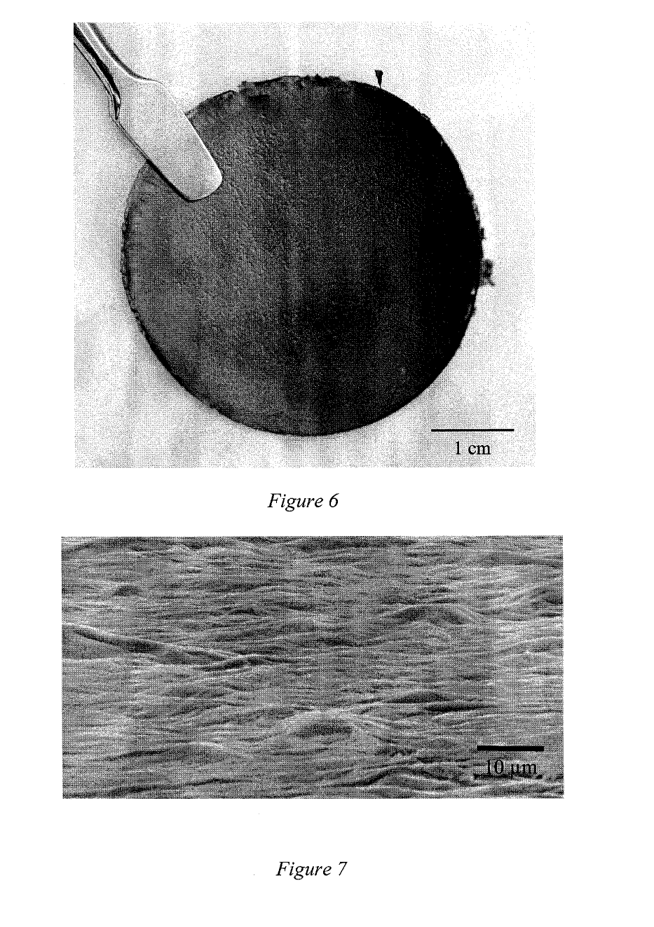

GO platelets have a mean thickness of 1±0.2 nm, and an estimated spacing of 0.5±0.2 nm that is attributed to oxide surface groups of the GO. A GO PEM was prepared by using a 3 mg/mL concentration of graphene dispersion mixed using magnetic stirring to promote uniform colloidal dispersion. The dispersion was vacuum filtrated through a 0.45 micron polyamide filter to form a laminated GO membrane. FIG. 6 shows a GO membrane, fabricated from GO platelets. Scanning electron microscopy (SEM) of the membrane's cross-section reveals a laminated structure, as shown in FIG. 7.

A set of tests was conducted to determine the membrane structure and composition. FTIR spectroscopy was carried out using Thermo Scientific Nicolet iS10 FT-IR spectrometer conducted to determine the surface functional groups. X-Ray Photoelectron Spectroscopy (XPS) was performed on GO platelets, with an Aluminum source on a Perkin Elmer 5100 XPS System at an angle of 45 (degrees). A survey scan was performed over 10 sweeps, ranging from 1000 eV to 0 eV binding energy, at a rate of 10 seconds per sweep. A multiplex scan over 10 sweeps was performed to analyze the carbon peak from 292 eV to 282 eV binding energies at a rate of 10 s per sweep. Transmission electron micrographs (TEM, JEM-ARM200CF) were taken at 80 kV to identify the surface features present on a single GO flake. X-ray diffraction (XRD, X'Pert Powder) was conducted to investigate the inter-layer spacing of the GO laminate.

The ion exchange capacity (IEC) of the membranes was determined using a titration method. Membrane sample were soaked in 1M sodium chloride (NaCl) solution for 24 hours, after which the solution was titrated with 0.005M sodium hydroxide (NaOH) solution and the quantities used to calculate the IEC by Equation 1.

$$IEC = \frac{{M}_{NaOH , i} - {M}_{NaOH , f}}{{W}_{dry}} \qquad Equation 1$$

where M_{NaOH,i} is the initial mmol of NaOH of titration, and M_{NaOH,f} is the mmol of NaOH after equilibrium is reached, and W_{dry} is the weight of the dry GO membrane.

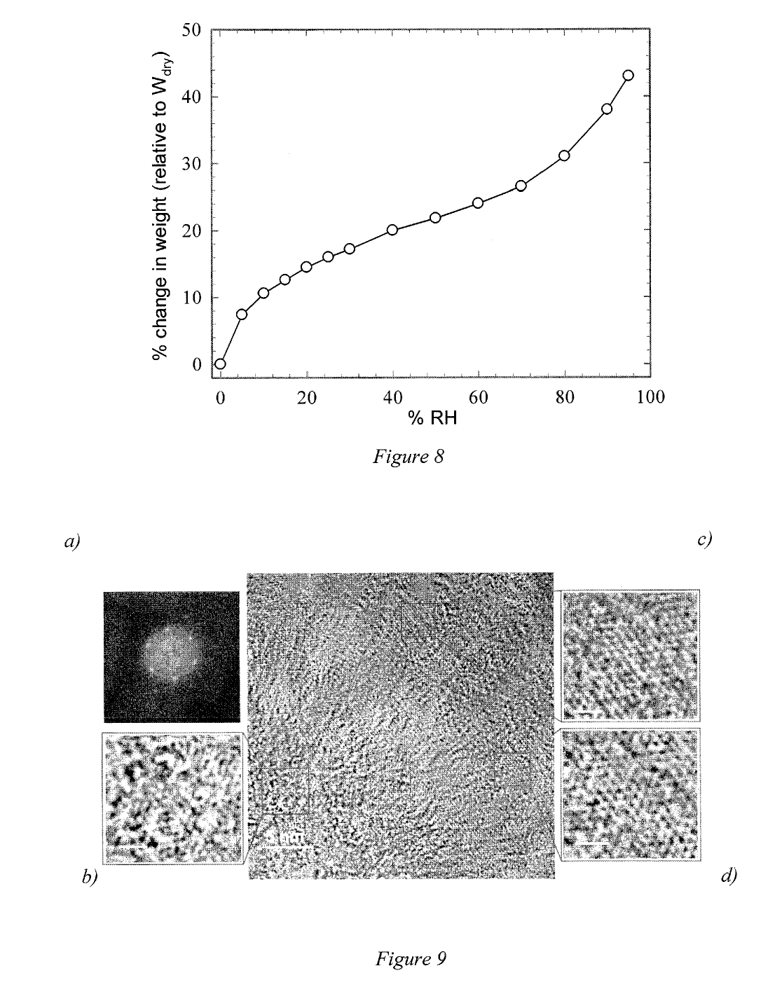

The water uptake capacity of the GO membrane is determined by subjecting the membrane to a desorption analysis using a SGA-100 Symmetrical Gravimetric Analyzer (VTI Corp.). The membranes were placed in the test chamber and fully humidified. The relative humidity (% RH) was decreased in discrete steps, and membrane weight was measured after each step. The dry weight of the membrane (W_{dry}) was measured after maintaining the membrane at 0% RH for 8 hours. Water uptake is plotted in FIG. 8.

The functional groups observed indicate that the surface of a layered GO material consisting of oxygenated graphene sheets, with oxygen functional groups present on its basal planes and edges. These oxidative groups are responsible for the hydrophilicity of GO. The FT-IR spectrum of GO displays absorption bands corresponding to carboxylic/carbonyl stretching at 1715 cm⁻¹, C═C stretching at 1648 cm⁻¹, C—O stretching at 1048 cm⁻¹ and C—OH/Ph—OH stretching at 3220 cm⁻¹, as shown in FIG. 3b). The C1s XPS spectrum of the prepared GO is shown in FIG. 3a, where the binding energy of 285 eV is assigned to C—C bonding, and chemical shifts of +1.5 eV, +2.5 eV and +4 eV are assigned to C—OH/Ph—OH, carbonyl, and carboxylic bonding, respectively. These oxidative groups impart a high IEC value of 1.06 meqg⁻¹ to the GO membrane, where the IEC changed by 0.05 as the water uptake capacity changed from 40% to 43%, which is higher than the IEC value measured for Nafion 117® (0.94 meqg⁻¹).

Under hydrated conditions, water molecules form nano-capillaries between GO platelets that serve as conduction pathways and surface defects (holes) within the GO platelets provide through-plane transport pathways. FIG. 1 depicts transport pathways within a GO laminate. As implied in FIG. 1, the length of transport pathways, and consequently the mass transport rate across the GO laminate, is directly proportional to the mean flake size of GO. The linear relation between methanol permeability and mean flake size, as shown in FIG. 2, further illustrates the dependence of mass transport rate on the mean flake size.

FIG. 2 also indicates that the difference in flake size has insignificant effect on the proton conductivity, where the largest flake size membrane is only 20% less conductive than the smallest flake size membrane, which has a proton conductivity of 4.93×10⁻³ Scm⁻¹. This implies existence of proton selective atomic formations and defects within the GO platelets, which is consistent with the known highly inhomogeneous atomic structure of GO relative to a pristine graphene sheet.

TEM images of GO flakes, shown in FIG. 9, indicate the presence of surface features and defects of various sizes. The smaller defects, illustrated in FIGS. 9c and d, may permit transport of protons, while being impermeable to a larger methanol molecule. Among the atomic formations that contribute to proton transport across the GO sheet are acidic groups, such as C—OH, that may facilitate proton sharing or hopping across the GO sheet or defects that allow protons to hop between two water molecules situated on opposite sides of a GO sheet. The transport of protonated water molecules and methanol molecules potentially is restricted to transport through relatively bigger defects, illustrated in FIGS. 9b and c, predominantly following the path illustrated in FIG. 1, which is highly impacted by the flake size.

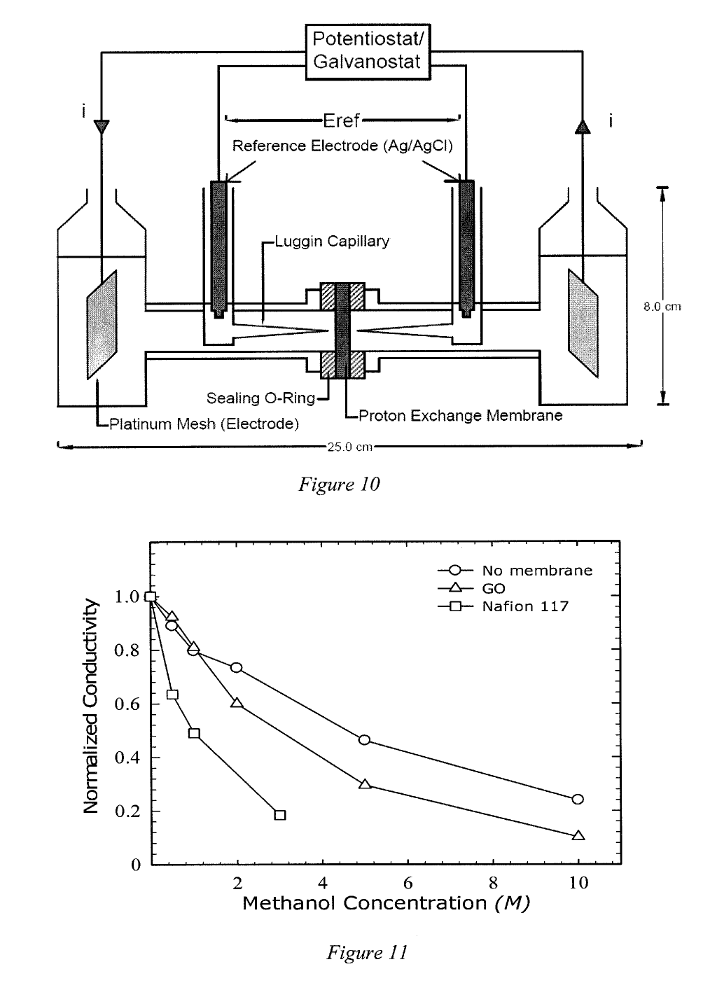

FIG. 10 shows a schematic of a glass cell used to measure the proton conductivity of the PEMs. Measurements were made by four-probe multi-step chronopotentiometry using a Gamry (Reference 3000) frequency response analyzer and potentiostat. The outer electrodes (Platinum Mesh) are connected to the working and counter electrodes on the Gamry potentiostat, and the two inner electrodes are connected to the reference electrodes (Ag/AgCl). Current is swept from 0-200 mA between the Pt electrodes. The resulting potential drop is measured by the reference electrodes placed very close to the membrane. Proton conductivity of Nafion® 211 (25 μm thickness) and Nafion® 117 (175 μm thickness) membranes were measured in addition to GO membranes prepared from the three different platelet sizes (15.8 μm, 10.4 μm and 2 μm). For all membranes, the current sweep over the entire range was repeated three times, which yielded the proton conductivity of the respective membrane on 9000 different data points. The overall proton conductivity of the membrane is measured by taking a mean of all obtained values. The error incurred in the measurement of these values was approximately 4%. The resistance to proton conduction was measured to be 0.05Ω for Nafion® 211, and 0.37Ω for Nafion® 117, indicating a linear dependence on membrane thickness. The overall proton conductivity per unit thickness for Nafion® was calculated to be 0.05 S/cm. Proton conductivity measurements showed that the membrane made with platelet size of 15.8 μm is only 20% less conductive than one made with 2 μm platelets. Measurements on the effects of methanol concentration on a Nafion® PEM's and a GO PEM's proton conductivity are plotted in FIG. 11. The degree of decline in proton conductivity with methanol concentration was significantly less for the GO PEM than that of the Nafion® PEM. The GO PEMs do not swell in highly concentrated methanol solutions, unlike Nafion® PEMs that exhibit excessive swelling and disintegration under similar test conditions.

A glass cell, similar to FIG. 10, but without electrodes was used for methanol crossover measurements of Nafion® and GO membranes cut into 1 cm² diameter discs and mounted in a test cell. One chamber was filled with 5 M methanol in water, and the other chamber was filled with DI water. Both chambers were stirred continuously, and after a few hours, the DI water side of the cell was sampled. The samples were analyzed with a NMR spectroscope (500 MHz Varian INOVA 2) with a 0.5 M acetic acid solution in deuterated water as the NMR solvent. A calibration was constructed from the peak intensity ratios of various methanol concentrations, which gave a linear relationship of the NMR ratios. Using this empirical equation, the methanol molarities after crossover were obtained from the intensity ratios for NMR signals from methanol and acetic acid. After obtaining the methanol flux across the membrane, the permeability of the membrane was calculated using Fick's law, Equation 2, below, for diaphragm-cell diffusion, assuming well mixed solutions in both chambers, and assuming the flux across the membrane quickly establishes a pseudo steady-state value,

j=P ΔC/δ Equation 2

where j is the methanol flux across the membrane (molcm⁻²s⁻¹), P is the permeability (cm²s⁻¹), δ is the membrane thickness (cm), and ΔC is the difference in concentration between the two chambers (molcm⁻³). Permeability values measured using this method yielded an error ranging between 5-7% for GO and Nafion® membranes. Methanol crossover values of Nafion® 117 were measured to be 1.8×10⁻⁵ cm²s⁻¹. Methanol permeability tests on GO PEMs clearly showed methanol permeation. However, it was found that the methanol diffusivity of different GO laminates, as indicated in FIG. 2, varies significantly with the platelet size. It is evident that crossover rate decreases almost linearly with increase in platelet size. Overall, three orders of magnitude lower methanol diffusivity than that of the Nafion® PEMs was observed.

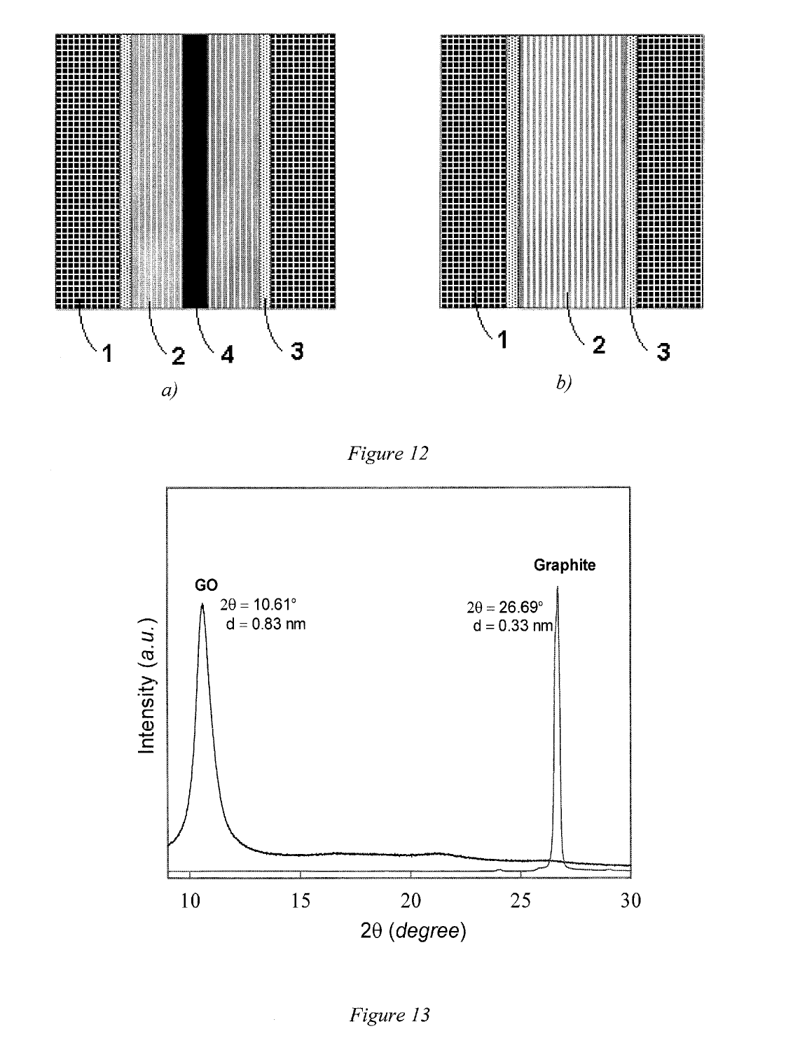

Membrane electrode assemblies (MEAs) with a geometric area of 5.0 cm² were prepared using fuel-cell-grade platinum-black (Alfa Aesar) and 1:1 platinum-ruthenium alloy powders (Alfa Aesar), each at a loading of 4.0 mgcm⁻², as the cathode and anode catalysts, respectively. MEA inks were prepared using Nafion® as the catalyst binder, according to the method of Wilson et al., Electrochim. Acta. 1995, 40, 355-63, incorporated herein by reference. Attempts to prepare stand-alone GO MEAs by hot pressing electrodes directly on the GO film damaged the membrane with the MEA disintegrating shortly after the start of cell operation. To demonstrate the fuel cell performance of the membrane, a GO laminate was formed by placing a barrier layer of GO between two 25 μm thick Nafion 211® membranes, one with an anode electrode and the other with a cathode electrode, as illustrated in FIG. 12a. For comparison, a conventional MEA was prepared using a 50 μm thick Nafion 212® film, as shown in FIG. 12b. Steady-state current density vs. voltage data were collected using a Scribner Series 890B fuel cell test station with mass flow and temperature controls. The fuel cell was operated at 60° C. and ambient pressure with humidified air at 500 sccm and 5 M or 10 M methanol supply at a flow rate of 2 mLmin⁻¹.

Freestanding membranes, as shown in FIG. 6, prepared by vacuum filtrations of aqueous GO dispersions displayed a layered structure from its X-ray diffraction pattern, as shown in FIG. 13. The GO peak in the X-ray spectrum (2θ=10.61°) corresponds to a layer-to-layer distance (d-spacing) of 0.83 nm that increases upon hydration because of the intercalation of water molecules in the interlamellar space. Water intercalation allows a high water uptake capacity of the GO laminate, as indicated in FIG. 8, which achieves a maximum water uptake at 43%, as compared to the 23% uptake in Nafion 117®.

Measured properties of Nafion® 117 and GO laminates are presented in Table 1, below. Water uptake capacity and IEC are significantly higher for GO membranes. This could be attributed to the oxidative groups present on its surface. When compared to Nafion®, the measured values of methanol permeability for all the GO membranes are significantly lower. GO-1, the membrane from the lagest GO flakes, has the lowest methanol permeability, which is three orders of magnitude lower than that measured for Nafion®, which agree with that disclosed as 0.92×10⁻⁵ cm²s⁻¹ for 5 M methanol, Ramya et al., .J Electroanal. Chem., 2003, 542, 109-15, and 1.68×10⁻⁵ cm²s⁻¹ for 42% aqueous methanol, Cruickshank et al., J. Power Sources, 1998, 70, 40-7.

TABLE 1
Measured properties of GO and Nafion-117 ® membrane

| | Mean | Proton | Methanol | | | |
|---|---|---|---|---|---|---|
| | flake size | conductivity | Permeability | IEC | WU | Selectivity |
| | (μm) | (Scm⁻¹) · 10² | (cm²s⁻¹) · 10⁵ | (meqg⁻¹) | (%) | (Scm⁻³s) · 10⁻⁴ |
| GO-1 | 15.8 | 0.392 | 3.20 × 10⁻³ | 1.06 | 43 | 12.3 |
| GO-2 | 10.4 | 0.446 | 9.72 × 10⁻³ | 1.06 | 43 | 4.6 |
| GO-3 | 2 | 0.493 | 1.83 × 10⁻² | 1.06 | 43 | 2.7 |
| Nafion-117 ® | — | 4.8 | 1.8 | 0.94 | 23 | 0.26 |

Overall, the measured selectivity of GO membranes is as high as 1.23×10⁵ Scm⁻³s (for GO-1), which is two orders of magnitude higher than that of Nafion 117®. The measured value of selectivity reduces with the reduction in the flake size. The lowest selectivity of GO membranes is observed in the GO-3 membrane, which is reasonably close to the selectivity of 2.53×10⁴ Scm⁻³s that is disclosed in Lin et al. J. Power Sources, 2013, 237, 187-94.

An efficient fuel cell operation requires that the PEM maintains its proton conductivity and mechanical stability at high methanol concentration. FIG. 11 shows the impact of the methanol concentration on the proton conductivity of Nafion® and GO membrane, and compares them to the case when no membrane is present between the two chambers. In FIG. 11, conductivities are normalized to their respective conductivities in 0.5 M sulfuric acid solution, with no methanol present in the solution. Nafion 117® suffers the steepest drop in normalized conductivity with increasing methanol concentration. In contrast, variation in the proton conductivity of the GO membrane with increasing methanol concentration closely resembles having no membrane present between the two chambers. This is perhaps due to the relatively low acidity and/or a more uniform distribution of the surface groups on the GO surface resulting in a more uniform solvent distribution between the platelets.

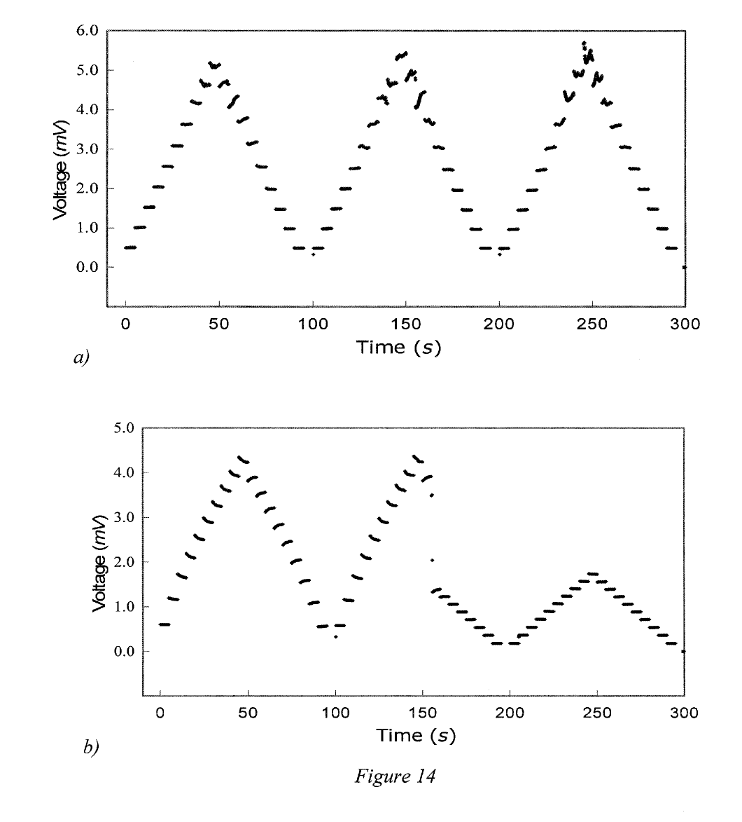

Mechanical stability of the membranes at high methanol concentration was examined. When subjected to excessive electro-osmotic drag, up to 1.3 Acm⁻², at elevated methanol concentrations, Nafion 117® lost its structural integrity at 3M methanol. The GO membrane survived similar conditions at 10 M methanol. As evident from FIG. 14, there is a sudden drop in the voltage response using the Nafion® membrane at 3M methanol, indicating a dramatic drop in the resistance across the membrane by leakage due to physical degradation of the membrane. It appears that segregation of water and methanol molecules within the Nafion® ion channels causes internal stress in Nafion® that leads to physical degradation; but no such internal stresses develops between GO platelets because a more uniform solution is maintained and imparts mechanical stability to GO at elevated methanol concentrations.

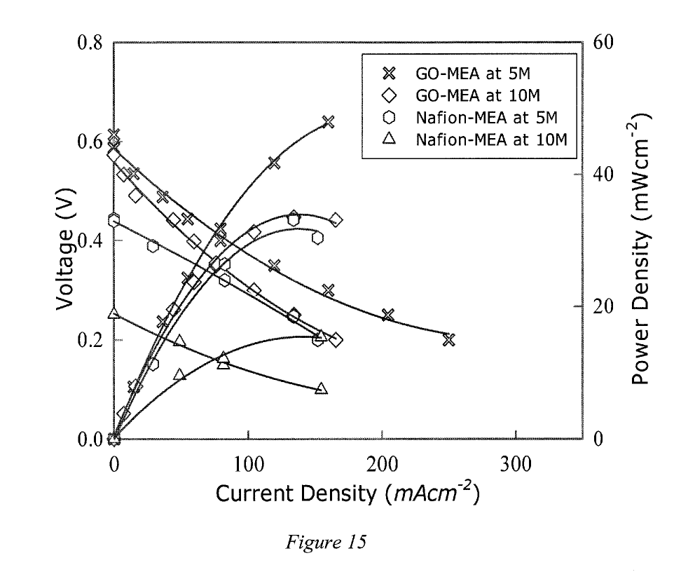

As plotted in FIG. 15, GO-based MEAs shows significant improvements in the performance at 5 and 10 M methanol when compared to a Nafion-212®-based MEA. Polarization curves of the GO-based MEA exhibit almost no drop in the open circuit potential (OCP) with an increase in the methanol concentration, indicating negligible fuel crossover; whereas, Nafion® suffered a significant drop in its OCP, rendering it ineffective at 10 M methanol. The polarization curve indicates an increase in the ohmic resistance by the GO-based MEA at 10 M methanol concentration, which may be due to the Nafion® in the GO-based MEA structure and the proton conducting domain within the catalyst layer. Despite experiencing an increase in ohmic losses, the GO-based MEA showed a 120% improvement in power density at 10 M methanol supply relative to a Nafion 212® based MEA.

All publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

We claim:

1. A proton exchange membrane (PEM), comprising a plurality of graphene oxide (GO) platelets or sulfonated graphene oxide (SGO) platelets, wherein the GO or SGO platelets have a mean diameter of at least 10 μm.

2. The PEM of claim 1, wherein the SGO platelets are chlorosulfonic acid treated GO platelets.

3. The PEM of claim 1, wherein the GO or SGO platelets have a mean size of at least 15 μm in diameter.

4. The PEM of claim 1, wherein the GO or SGO platelets are combined as a laminate having a thickness of 1 to 20 μm.

5. A Membrane electrode assembly (MEA), comprising a PEM according to claim 1.

6. The MEA of claim 5, further comprising at least one Nafion® membrane.

7. A direct methanol fuel cell (DMFC) comprising a PEM according to claim 1.
